(19) United States
(12) Patent Application Publication
(10) Pub. No.: US 2015/0099023 A1
(43) Pub. Date: Apr. 9, 2015

(54) NOZZLE PLATE FOR A GRANULATING DEVICE, AND GRANULATING DEVICE HAVING A NOZZLE PLATE

(71) Applicant: AUTOMATIK PLASTICS MACHINERY GMBH, Grossostheim (DE)

(72) Inventor: Reinhardt-Karsten Murb, Aschaffenburg (DE)

(21) Appl. No.: 14/568,349

(22) Filed: Dec. 12, 2014

Related U.S. Application Data
(63) Continuation of application No. PCT/EP2013/001751, filed on Jun. 13, 2013.

(30) Foreign Application Priority Data
Jun. 15, 2012 (DE) 102012012070.2

(51) Int. Cl. B29C 47/30; B29B 9/06

(52) U.S. Cl. CPC B29C 47/30; B29B 9/065; B29B 9/06
USPC 425/67; 425/72.1; 425/464

(57) ABSTRACT

A nozzle plate for a granulating device. The nozzle plate has a plurality of nozzles for the passage of melt, wherein the nozzles are arranged such that they lie on a circle about a center axis. Each nozzle has a nozzle channel and at least one nozzle opening. A recess for receiving a melt flow is formed on the surface of the nozzle plate opposite the surface comprising the nozzle opening. The recess can also be centered on the center axis. A plurality of flow channels in fluid communication with the recess and at least one flow channel are formed in the nozzle plate extending radially away from the center. A granulating device having such a nozzle plate.

### CROSS REFERENCE TO RELATED APPLICATIONS

The present patent application is a Continuation Application that claims priority to and the benefit of co-pending International Patent Application No. PCT/EP2013/001751, filed Jun. 13, 2013, entitled “NOZZLE PLATE FOR A GRANULATION DEVICE, AND GRANULATION DEVICE COMPRISING A NOZZLE PLATE”, which claims priority to DE Application No. 102012012070.2 filed Jun. 15, 2012, entitled “NOZZLE PLATE FOR A GRANULATION DEVICE, AND GRANULATION DEVICE COMPRISING A NOZZLE PLATE”. These references are incorporated in their entirety herein.

### FIELD

The present embodiments generally relate to a nozzle plate used for granulation of melt material comprising active pharmaceutical ingredients or thermoplastic materials.

### BACKGROUND

In general, devices with extruders or melt pumps are used for granulating melt material, such as melt materials comprising active pharmaceutical ingredients or thermoplastic material such as polyethylene or polypropylene. I these devices, molten material is pressed through a die plate into a cooling fluid, such as water, and is cut there by a blade passing over the openings of the die plate, thereby producing pellets.

In prior art granulating devices, nozzle plates are customarily used for this purpose. A typical nozzle plate can have a plurality of nozzles arranged in the shape of a circle on the nozzle plate in order to permit the passage of molten material, hereinafter referred to as melt, through the nozzle plate.

In components located upstream of the nozzle plate, such as an adapter plate, an inlet housing, or a startup valve, there can be an opening for the melt being fed to the nozzles that widens in the direction of the nozzle plate.

In order to assist the distribution of the melt among the nozzles and routing melt to the nozzles, a nose cone is generally provided within the passage, which can be attached to the back of the nozzle plate. The melt is therefore delivered to the nozzle plate in such a way that it arrives at the nozzle plate in a ring shape proximate to the nozzle openings.

Corresponding designs are known in the industry and prior art.

Since the melt in such devices can be guided to the nozzle plate in a ring shape by means of the opening and the nose cone, it is possible for dead zones to form in the regions between the nozzles where melt material collects without being dislodged. If these accumulations form with a non-uniform distribution, the melt flow through the nozzles can be distorted and can become non-uniform.

Furthermore, individual portions of the melt in the large, wide cavity spanned by the opening and the nose cone can arrive at the nozzles by many different paths having different lengths, so the individual portions can have different travel times or dwell times. These influences can negatively impact the quality of the granules to be produced, and in particular can result in non-uniformities and variations in the granule quality.

This design is resource-intensive, since appropriate parts or components must be provided to form the widening opening and the nose cone. In particular, the overall length of the granulator as a whole is increased due to length required for the opening and nose cone. If the operation of such a granulator is changed over to a new melt material, an undesirable, a relatively large quantity of waste material results, which raises costs, especially in the case of relatively expensive melt materials such as pharmaceutical active ingredients.

One object of the present invention is to overcome the abovementioned disadvantages and to specify a granulating device with improved melt routing.

Another object of the present invention is to specify a granulating device with reduced overall length.

These and other objects of the present invention are attained by the present embodiments.

### BRIEF DESCRIPTION OF THE DRAWINGS

The detailed description will be better understood in conjunction with the accompanying drawings as follows:

FIG. 1 shows an embodiment of a nozzle plate in a perspective view of its rear side.

FIG. 2 shows a top view of the rear side of the nozzle plate from FIG. 1.

FIG. 3 is a cross-sectional view along the section B-B from FIG. 2.

FIG. 4 schematically shows a section of a granulating device that contains the nozzle plate from FIG. 1.

FIG. 5 shows a nozzle plate according to a second embodiment of the invention.

FIG. 6 shows a nozzle plate according to a third embodiment of the invention.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The present invention relates to a nozzle plate for a granulating device having a plurality of nozzles for the passage of melt, wherein the nozzles are arranged such that they lie substantially on a circle about a center axis, and wherein each nozzle comprises a nozzle channel and at least one nozzle opening. A recess for receiving a melt flow is formed in the back of the nozzle plate, wherein the recess is centered around the center axis. In addition, a plurality of flow channels are formed in the nozzle plate, wherein the flow channels each extend from the recess in a direction parallel to the rear surface and radially away from the center axis to one of the plurality of nozzles.

In a granulating device that uses such a nozzle plate, a melt flow can be fed to the recess in a straight line. In the recess the melt flow is deflected essentially by 90 degrees so that the melt flow is distributed among the flow channels and is transported radially outward in each of the flow channels perpendicular to the center axis so as to flow into the nozzle channels of the nozzles. The melt flow is again deflected essentially by 90 degrees in the nozzle channels, and the melt flows parallel to the center axis through the nozzles to exit through the nozzle openings, where the melt can be severed with blades of a cutter head.

In this way, a melt flow with no dead zones is achieved, as there is no place for melt material to collect. Because of the oriented and direct routing of the melt through the recess and the flow channels, it is also possible to ensure that all portions of the melt are routed to the nozzles following a path that is well-defined and essentially identical in each case, so all portions of the melt have essentially the same travel time.

The necessity for providing components in a granulating device upstream of the nozzle plate that widen a melt flow present melt at the nozzles in a ring shape is eliminated. As a result, it is possible to shorten the overall length of the granulating device.

A longitudinal axis of any given flow channel can be substantially perpendicular to the longitudinal axis of the nozzle channel of the associated nozzle.

The longitudinal axes of the flow channels can be substantially perpendicular to a direction along which the melt flow is directed to the recess.

The nozzles can be arranged symmetrically on a circle such that any two adjacent nozzles are equidistant. This further improves the balancing of the routing of the melt through the various nozzles.

The flow channels can have a width corresponding to, or related to the diameter of the nozzle channels. Transition from a flow channel into a nozzle channel can be rounded in conformity with a transition radius. In this way, sudden changes in cross-section and/or edges or projections, which could disrupt and negatively affect the flow of melt, are avoided.

The flow channels can be implemented as grooves in the rear face of the nozzle plate, such as grooves with a U-shaped cross-section. The U-shaped cross-section can also be implemented as a semicircular cross-section with a circular radius corresponding to half the width of the groove, or other shapes as applicable for desired flow of melt.

The recess can be circular. The recess can have a cross-section that corresponds to a multiple of the sum of the cross-sections of the flow channels. In embodiments, the cross-section of the recess can be at least twice the sum of the cross-sections of the flow channels.

The recess can have a lateral surface that tapers in the form of a circular arc, with a radius that is substantially similar to the radius of the flow channels. The recess can also have a bottom formed by a cone extending into the recess, wherein the cone preferably rises essentially to the plane of the rear face.

With this design, corners and other regions where melt can collect are eliminated, and the flow behavior of the melt and distribution into the flow channels is improved and more consistent.

The nozzle plate can also be implemented in two parts, with a first nozzle plate body and a second nozzle plate body. Nozzle openings and at least a section of the nozzle channel of the nozzles can be implemented in the first nozzle plate body, and recess and the flow channels can be implemented in the second nozzle plate body.

With a nozzle plate that is implemented in two parts, it is possible to replace only the first nozzle plate body in the event of wear of the nozzle opening side. The nozzle opening side will wear faster than the side with the recess and the flow channels due to constant contact with blades of a cutter. Since this first nozzle plate body is simpler and more economical to manufacture than a one-piece nozzle plate, installation and maintenance costs can be significantly reduced.

When the product to be granulated is being changed over to a different product with different material properties it is often necessary to change the opening width of the nozzle openings as well. With a two-part nozzle plate, it is sufficient in this case to exchange only the first nozzle plate body.

Thus, it is only necessary to stock a number of different first nozzle plate bodies with different nozzle opening sizes in order to be equipped for efficient product changeovers. This represents a more economical and cost-effective solution as compared to stocking more expensive one-piece nozzle plates, which are more costly to produce and would have to be stocked for every required nozzle opening width.

The nozzle plate can be part of a granulating device. The granulating device can be a hot-cut granulating device. In particular, the granulating device can be an air-cooled hot die-face granulating device or an underwater granulating device as are well known to persons having ordinary skill in the art.

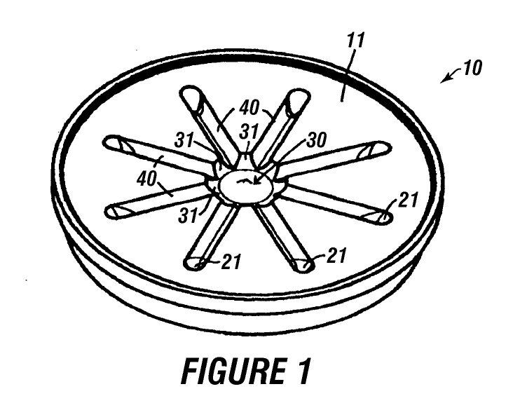

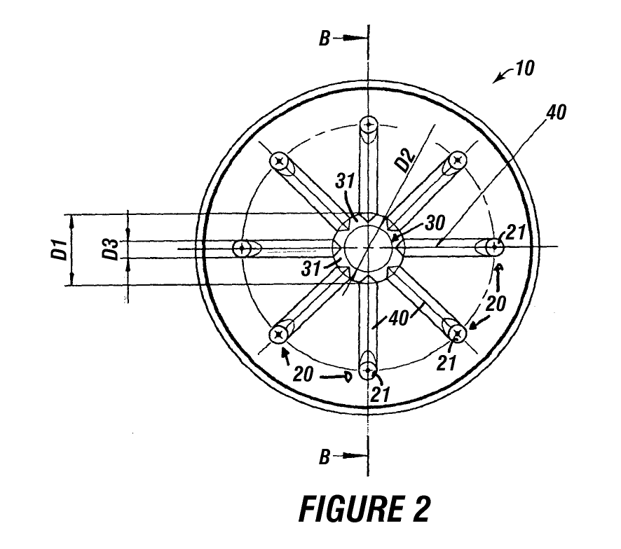

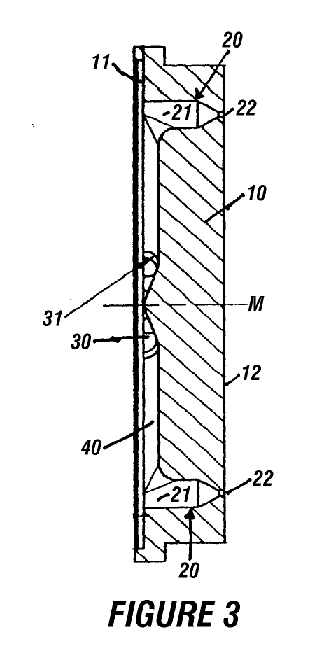

Turning now to the Figures, FIG. 1 shows a nozzle plate according to a first embodiment of the invention in a perspective view of its rear side. FIG. 2 is a top view of the rear side of the nozzle plate from FIG. 1. FIG. 3 is a cross-sectional view along the section B-B from FIG. 2.

With respect to FIGS. 1-3, a first a nozzle plate 10 is described.

A plurality of nozzles 20 can be formed in the nozzle plate 10. The present embodiment is shown with eight nozzles 20, but any other desired number of nozzles 20 may also be formed in the nozzle plate 10. Each of the nozzles 20 can have a nozzle channel 21 and a nozzle opening 22 through which melt material can emerge on the side of the nozzle plate 10 referred to here as the front side 12 in order to be severed by blades of a cutter head.

The nozzles 20 can be arranged in the nozzle plate 10 such that they lie substantially on a circle around a center axis M, such that all nozzles 20 have the same distance from the center axis M. The nozzles 20 can be distributed unevenly over the circle. The nozzles 20 can also be distributed uniformly on the circle such that any two adjacent nozzles 20 are equidistant.

It is also possible (not shown in the figures) for the nozzles 20 to be located on multiple circles centered on axis M with different radii. Alternatively, the multiple circles need not be centered on the same point or axis. In this case, separate flow channels 40 can be associated with each circle.

A plurality of flow channels 40 can be located in the back of the nozzle plate 10, wherein each flow channel 40 is associated with a respective nozzle 20 and opens onto the nozzle channel 21 of the corresponding nozzle 20.

The flow channels 40 can have a rectangular, trapezoidal, circular, or any desired shape in cross-section. The flow channels can be implemented as grooves with U-shaped or semicircular cross-sections in the rear sides of the nozzle plate 10.

The flow channels 40 can have a width corresponding to the diameter of the nozzle channels 21. The transition from a flow channel 30 into the corresponding nozzle channel 21 can be rounded as shown in FIG. 3. The rounding can correspond to a circular arc with a radius corresponding to half the width of the flow channel.

The flow channels 40 extend parallel to the rear surface of the nozzle plate 10 straight toward the center axis M and open onto a recess 30 formed in the back of the nozzle plate 10.

A shown, the recess 30 intersects the rear surface along a circle with a diameter D1. The recess 30 serves to receive a melt flow from a device upstream of the nozzle plate and distribute the melt among the flow channels. The inflow of the melt into the recess 30 in this design takes place in the direction of the center axis M, which is to say substantially perpendicular to the rear surface of the nozzle plate.

The cross-section of the recess 30 (circular area of the circle with radius D1 according to FIG. 2) can dimensioned such that it corresponds to a multiple of the sum of the cross-sections of the flow channels. In embodiments, the cross-section of the recess is at least twice the sum of the cross-sections of the flow channels, and can be four or more times the sum of the cross-sections of the flow channels.

The recess 30 can also have a lateral surface 31 that delimits the recess 30. The lateral surface 31 can taper in the form of a circular arc toward the interior of the nozzle plate 10 with a radius that can correspond essentially to the radius of the flow channels.

A cone can be formed at the bottom of the recess 30 extending into the interior of the recess 30. The cone can rise essentially to the height of a plane of the rear face 11 of the nozzle plate 10.

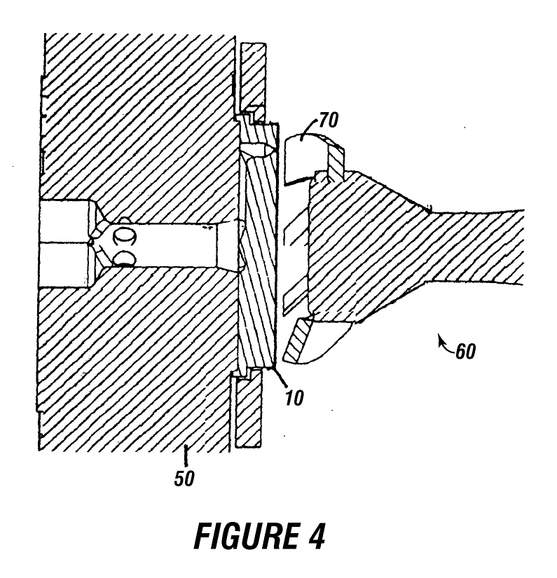

The nozzle plate 10 described above with reference to FIGS. 1 to 3 can be part of a granulating device, in particular a granulating device based on the underwater granulating principle or the hot-cut granulating principle. This is shown by way of example in FIG. 4, which shows a granulating device having a nozzle plate 10.

FIG. 4 schematically shows a section of a granulating device that contains the nozzle plate 10 of FIG. 1.

Adjacent to the rear side 11 of the nozzle plate 10 is a plate-like device 50 that can represent an adapter plate, an inlet housing, a startup valve, and the like. The device 50 can have a recess through which melt material is guided to the recess 30 of the nozzle plate 10. The device 50 can cover the regions of the rear side 11 of the nozzle plate 10 where the flow channels 40 are located, so as to close the flow channels.

Shown downstream of the nozzle plate 10 is a cutter device 60 with at least one blade 70 that sweeps over the front side 12 of the nozzle plate to sever plastic material pressed out of the nozzle openings.

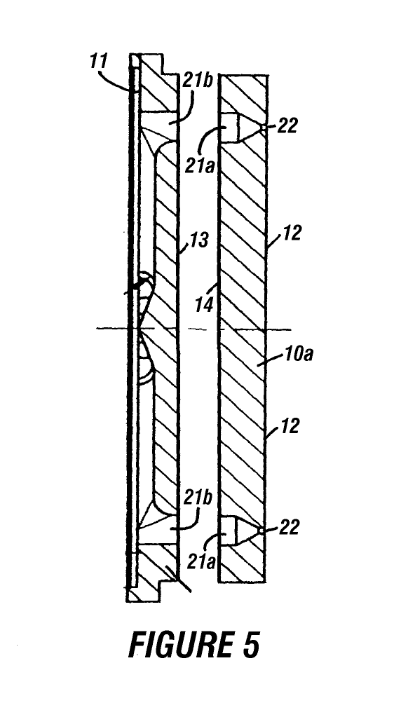

FIG. 5 shows a nozzle plate according to a second embodiment of the invention. The nozzle plate in FIG. 5 is implemented in two parts, with a first nozzle plate body 10a and a second nozzle plate body 10b.

The recess 30 and the flow channels 40 are implemented in the rear surface 11 of the second nozzle plate body. The flow channels 40 each open into a nozzle channel section 21b that extends through the second nozzle plate body 10b. Formed in the first nozzle plate body are corresponding further nozzle channel sections 21a that open into the nozzle openings 22. Together, the nozzle channel sections 21a that are implemented in the first nozzle plate body 10a and the nozzle channel sections 21b that are implemented in the second nozzle plate body 10b form the nozzle channels 21 of the nozzles 20.

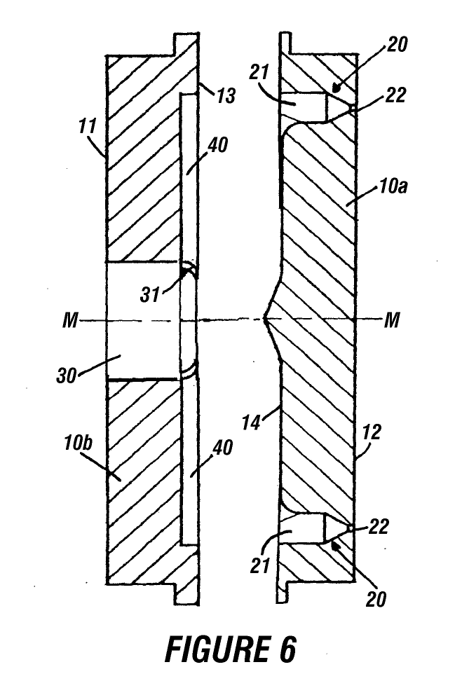

FIG. 6 shows a nozzle plate according to a third embodiment of the invention.

In the present embodiment, the nozzle plate is implemented in two parts, with a first nozzle plate body 10a and a second nozzle plate body 10b.

The nozzles 20 with the nozzle channels 21 and the nozzle openings 22 are implemented in the first nozzle plate body 10a.

The recess 30 is implemented in the second nozzle plate body 10b such that the recess 30 extends through the second nozzle plate body 10b. The bottom of the recess 30 is formed by a rear side 14 of the first nozzle plate body 10a. The cone can be implemented on the rear side 14 of the first nozzle plate body 10a in the region of the recess 30. The flow channels 40 are implemented in a front side 13 of the second nozzle plate body 10b and extend to a region where they cover the nozzle channels 21 implemented in the first nozzle plate body 10a.

While these embodiments have been described with emphasis on the embodiments, it should be understood that within the scope of the appended claims, the embodiments might be practiced other than as specifically described herein.

What is claimed is:

1. A nozzle plate for a granulating device, comprising:
a. a plurality of nozzles for the passage of melt, wherein each nozzle is located substantially on a circle about a center axis (M), and further wherein each nozzle comprises:
(i) a nozzle channel;
(ii) at least one nozzle opening;
b. a recess for receiving a melt flow formed on the nozzle plate on a surface opposite a surface comprising the plurality of nozzles, wherein the recess is centered around a center axis; and
c. a plurality of flow channels in fluid communication with the recess which radially extend to at least one nozzle of the plurality of nozzles.

2. The nozzle plate of claim 1, wherein a longitudinal axis of each flow channel is substantially perpendicular to a longitudinal axis of the nozzle channel with which the flow channel is in fluid communication.

3. The nozzle plate of claim 1, wherein a longitudinal axis of each flow channel is substantially perpendicular to a direction along which the melt flow is directed to the recess.

4. The nozzle plate of claim 1, wherein each nozzle of the plurality of nozzles equidistant to an adjacent nozzle.

5. The nozzle plate of claim 1, wherein each flow channel has a width equal to the diameter of the nozzle channel with which the flow channel is in fluid communication.

6. The nozzle plate of claim 1, wherein each flow channel is implemented as a groove on a surface opposite a surface comprising the plurality of nozzles.

7. The nozzle plate of claim 1, wherein each flow channel is implemented with a U-shaped cross-section.

8. The nozzle plate of claim 7, wherein the U-shaped cross-section is a semicircular cross-section with a radius corresponding to half the width of the groove.

9. The nozzle plate of claim 1, further comprising a transition radius between each flow channel and the nozzle channel with which the flow channel is in fluid communication.

10. The nozzle plate of claim 1, wherein the recess is substantially circular.

11. The nozzle plate of claim 1, wherein the recess has a cross-section which is at least twice the the sum of the cross-sections of the flow channels.

12. The nozzle plate of claim 1, wherein the recess has a lateral surface that tapers in the form of a circular arc.

13. The nozzle plate of claim 1, wherein a bottom of the recess is formed by a cone extending into the recess, wherein the cone rises essentially to the plane of the rear face.

14. The nozzle plate of claim 1, further comprising:
a. a first nozzle plate body comprising:
(i) the nozzle opening; and
(ii) a section of the nozzle channel of each nozzle; and
b. a second nozzle plate body comprising:
(i) the recess; and
(ii) the plurality of flow channels.

15. A granulating device comprising a nozzle plate, wherein the nozzle plate comprises:
a. a plurality of nozzles for the passage of melt, wherein each nozzle is located substantially on a circle about a center axis (M), and further wherein each nozzle comprises:
(i) a nozzle channel; and
(ii) at least one nozzle opening;
b. a recess for receiving a melt flow formed on the nozzle plate on a surface opposite a surface comprising the plurality of nozzles, wherein the recess is centered around a center axis; and
c. a plurality of flow channels in fluid communication with the recess which radially extend to at least one nozzle of the plurality of nozzles.

16. The granulating device of claim 15, wherein the granulating device is an air-cooled hot die-face granulating device or an underwater granulating device.
